(19) United States
(12) Patent Application Publication
(10) Pub. No.: US 2013/0265247 A1
(43) Pub. Date: Oct. 10, 2013

(54) TOUCH PANEL

(71) Applicant: HIMAX TECHNOLOGIES LIMITED, Tainan City (TW)

(72) Inventors: Sheng-Fan Yang, Tainan City (TW); Jui-Ni Lee, Tainan City (TW); Yaw-Guang Chang, Tainan City (TW); Shen-Feng Tai, Tainan City (TW)

(73) Assignee: HIMAX TECHNOLOGIES LIMITED, Tainan City (TW)

(21) Appl. No.: 13/745,344

(22) Filed: Jan. 18, 2013

(30) Foreign Application Priority Data
Apr. 10, 2012 (TW) 101112650

(51) Int. Cl. G06F 3/041

(52) U.S. Cl. CPC G06F 3/041
USPC 345/173

(57) ABSTRACT

A touch panel including a substrate and a sensing array is provided. The sensing array is disposed on the substrate and includes a plurality of sensing units. Each sensing unit has a first sensing electrode and a second sensing electrode which are arranged in a staggered manner and are electrically insulated from each other. The first sensing electrode includes two parallel first sensing pads and a first connection portion. The second sensing electrode includes two parallel second sensing pads and a second connection portion. The first sensing pads, the first connection portion, the second sensing pads, and the second connection portion are in rectangular shapes, and short sides of the first connection portion and the second connection portion are electrically connected to middle portions of long sides of the first sensing pads and the second sensing pads respectively. The second connection portion and the first connection portion intersect each other.

### CROSS-REFERENCE TO RELATED APPLICATION

This application claims the priority benefit of Taiwan application serial no. 101112650, filed on Apr. 10, 2012. The entirety of the above-mentioned patent application is hereby incorporated by reference herein and made a part of this specification.

### BACKGROUND OF THE INVENTION

1. Field of the Invention

The invention generally relates to a touch panel, and more particularly, to a capacitive touch panel.

2. Description of Related Art

Along with the fast advancement and broad application of information technologies, wireless mobile communications, and information appliances, the conventional input devices (for example, keyboards and mouses) of many information products have been replaced by touch panels in order to offer convenience, small volume, light weight, and intuitional experiences to the users.

Presently, touch panels can be categorized into resistive touch panels, capacitive touch panels, optical touch panels, acoustic wave touch panels, and electromagnetic touch panels. Among all different types of touch panels, resistive touch panels and capacitive touch panels are the most popular ones.

For example, a capacitive touch panel has a plurality of sensing electrodes, a plurality of signal lines, and a controller. When the touch panel is not touched by a user, an initial capacitance exists among the sensing electrodes. When the touch panel is touched by the user, the touched sensing electrode produces a mutual capacitance such that the original initial capacitance is changed. In this case, the controller determines the position touched by the user according to the position of the changed capacitance. Herein the variation between the mutual capacitance and the initial capacitance is the touch sensitivity.

Besides precisely determining the position touched by a user, a touch panel should offer a touch sensitivity that allows the user to use the touch panel smoothly. Each conventional capacitive touch panel comes with a large initial capacitance therefore cannot offer a satisfactory touch sensitivity. Thereby, with today's increasing demand of touch panels and the users' craving for operation smoothness, a touch panel offering high touch sensitivity has to be provided.

### SUMMARY OF THE INVENTION

Accordingly, the invention is directed to a touch panel offering high touch sensitivity.

The invention provides a touch panel including a substrate and a sensing array. The sensing array is disposed on the substrate. The sensing array includes a plurality of sensing units. Each of the sensing units includes a first sensing electrode and a second sensing electrode. The first sensing electrode includes two first sensing pads disposed in parallel and a first connection portion, and the first sensing pads and the first connection portion are in rectangular shapes. Two short sides of the first connection portion are respectively electrically connected to the middle portions of long sides of the first sensing pads. The second sensing electrode is arranged in a staggered manner with the first sensing electrode and is insulated from the first sensing electrode. The second sensing electrode includes two second sensing pads disposed in parallel and a second connection portion, and the second sensing pads and the second connection portion are in rectangular shapes. Two short sides of the second connection portion are respectively electrically connected to the middle portions of long sides of the second sensing pads. The second connection portion and the first connection portion intersect each other.

According to an embodiment of the invention, the first sensing pads and the first connection portion of the sensing unit are disposed on a first plane, the second sensing pads and the second connection portion of the sensing unit are disposed on a second plane, and the first plane is different from the second plane.

According to an embodiment of the invention, the first sensing pads and the first connection portion of the sensing unit are perpendicularly disposed, and the second sensing pads and the second connection portion of the sensing unit are perpendicularly disposed.

According to an embodiment of the invention, the first connection portion and the second connection portion perpendicularly intersect each other, and the first sensing pads and the second sensing pads do not overlap each other.

According to an embodiment of the invention, a plurality of first gaps exists between the first sensing pads and the second sensing pads, and a plurality of second gaps exists between the first sensing pads and the second connection portion.

According to an embodiment of the invention, the width of each first gap is 0.3 mm.

According to an embodiment of the invention, the length of each first sensing pad is 3.7 mm.

According to an embodiment of the invention, the width of each second sensing pad is 0.5 mm.

According to an embodiment of the invention, the width of the second connection portion is 1 mm.

According to an embodiment of the invention, the touch panel further includes a plurality of signal lines and a controller. The first sensing electrodes and the second sensing electrodes are respectively electrically connected to the controller through the signal lines.

According to an embodiment of the invention, the second connection portion has a hole, and the second connection portion and the first connection portion intersect each other at the hole.

As described above, in a touch panel provided by an embodiment of the invention, the overlapping area between a second sensing electrode and a first sensing electrode can be reduced to reduce the initial capacitance of the touch panel and improve the touch sensitivity thereof.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating an example of a sensing array of a touch panel.

FIG. 2 is a top view of a touch panel according to an embodiment of the invention.

FIG. 3 is a top view of a touch panel according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

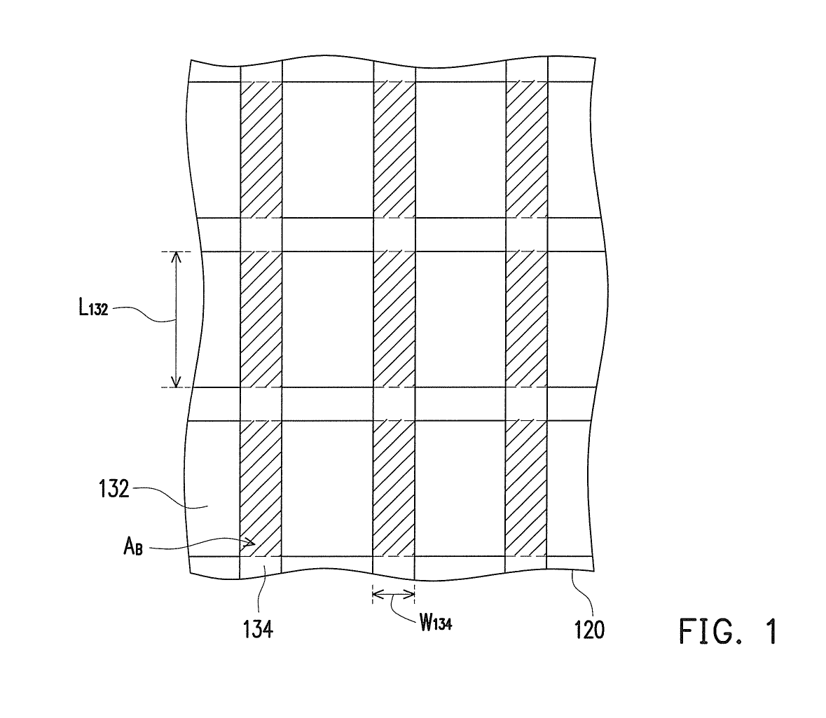

FIG. 1 is a diagram illustrating an example of a sensing array of a touch panel. Referring to FIG. 1, the sensing array 120 of a bar type touch panel includes a plurality of sensing units, and each of the sensing units includes a first sensing electrode 132 and a second sensing electrode 134. The first sensing electrode 132 and the second sensing electrode 134 are arranged in a staggered manner and are insulated from each other. To be specific, the first sensing electrode 132 and the second sensing electrode 134 can be made of any conductive material (including transparent conductive materials, such as indium tin oxide (ITO), and opaque conductive materials, such as metal). A dielectric layer is disposed between the first sensing electrode 132 and the second sensing electrode 134 to electrically insulate the first sensing electrode 132 and the second sensing electrode 134 from each other.

In the present embodiment, the width L₁₃₂ of the first sensing electrode 132 may be 4.5 mm, and the width W₁₃₄ of the second sensing electrode 134 may be 1 mm. There is an overlapping area A_{B} between the first sensing electrode 132 and the second sensing electrode 134. To be specific, the overlapping area A_{B}=L₁₃₂*W₁₃₄=4.5 mm². The first sensing electrode 132 and the second sensing electrode 134 form a parallel-plate capacitor at the overlapping area A_{B}. The formula for parallel-plate capacitance is C=ε*A/d, where c is the dielectric constant of a dielectric layer between two parallel plates (i.e., the first sensing electrode 132 and the second sensing electrode 134), A is the overlapping area A_{B} between the first sensing electrode 132 and the second sensing electrode 134, and d is the distance between the first sensing electrode 132 and the second sensing electrode 134. When the touch panel is not touched by the user, the parallel-plate capacitor has a first initial capacitance. A larger overlapping area A_{B} results in a greater first initial capacitance in the sensing units.

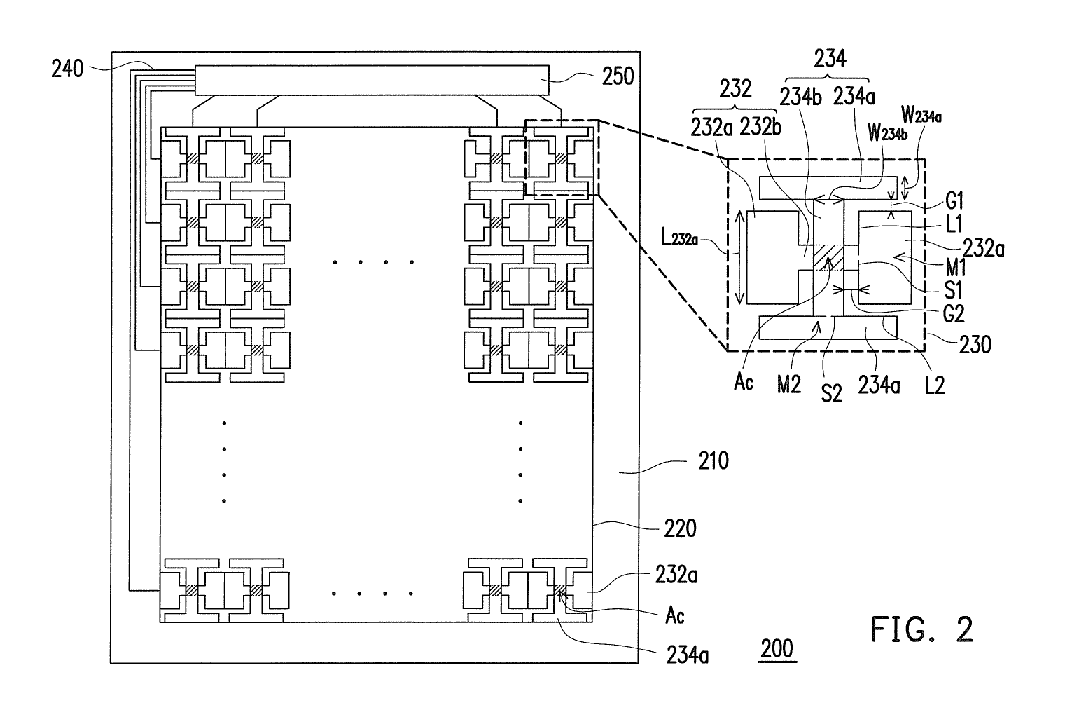

FIG. 2 is a top view of a touch panel according to an embodiment of the invention. Referring to FIG. 2, the touch panel 200 in the present embodiment includes a substrate 210 and a crucifix type sensing array 220 disposed on the substrate 210. The sensing array 220 includes a plurality of sensing units 230 that are arranged into an array to achieve a surface sensing effect. To be specific, each sensing unit 230 includes a first sensing electrode 232 and a second sensing electrode 234. Herein the second sensing electrode 234 and the first sensing electrode 232 are arranged in a staggered manner and are electrically insulated from each other.

To describe the present embodiment clearly and to avoid overlapped marking lines, only part of those symmetrical components is marked in FIG. 1, while the identical components of the other part are not marked. The first sensing electrode 232 includes two first sensing pads 232a that are disposed in parallel and a first connection portion 232b. The first sensing pads 232a and the first connection portion 232b are in rectangular shapes. As shown in FIG. 1, two short sides S1 of the first connection portion 232b are electrically connected to the middle portions M1 of the long sides L1 of the first sensing pads 232a respectively. In the present embodiment, the first connection portion 232b and the first sensing pads 232a are perpendicularly disposed. However, the invention is not limited thereto.

The second sensing electrode 234 includes two second sensing pads 234a that are disposed in parallel and a second connection portion 234b. The second sensing pads 234a and the second connection portion 234b are in rectangular shapes. As shown in FIG. 1, two short sides S2 of the second connection portion 234b are electrically connected to the middle portions M2 of the long sides L2 of the second sensing pads 234a respectively. In the present embodiment, the second connection portion 234b and the second sensing pads 234a are perpendicularly disposed. However, the invention is not limited thereto, and the angle between the second connection portion 234b and the second sensing pads 234a can be determined according to the product requirement.

To be specific, in the present embodiment, the second connection portion 234b and the first connection portion 232b intersect each other and form an overlapping area A_{C} at the intersection, and the first sensing pads 232a and the second sensing pads 234a do not overlap each other. Besides, in the present embodiment, there is a plurality of first gaps G1 between the first sensing pads 232a and the second sensing pads 234a, and there is a plurality of second gaps G2 between the first sensing pads 232a and the second connection portion 234b. In the present embodiment, the width of each first gap G1 is 0.1 mm or 0.3 mm. However, the invention is not limited thereto.

The first sensing electrode 232 and the second sensing electrode 234 may be made of any conductive material, such as a transparent conductive material or an opaque conductive material (for example, metal). In the present embodiment, the first sensing electrode 232 and the second sensing electrode 234 may be made of the same transparent conductive material or different transparent conductive materials. In the present embodiment, the first sensing electrode 232 and the second sensing electrode 234 may be made of indium tin oxide (ITO). Besides, the first sensing electrode 232 and the second sensing electrode 234 may be aimed as two transparent conductive layers. To be specific, the first sensing pads 232a and the first connection portion 232b of the first sensing electrode 232 are located on a first plane, and the second sensing pads 234a and the second connection portion 234b of the second sensing electrode 234 are located on a second plane. In the present embodiment, the second plane is disposed on the first plane. However, the invention is not limited thereto, and in other embodiments, the first plane may also be disposed on the second plane.

Additionally, in the present embodiment, a dielectric layer may be selectively disposed between the second sensing electrode 234 and the first sensing electrode 232 to electrically insulate the second sensing electrode 234 from the first sensing electrode 232. However, the invention is not limited thereto, and in other embodiments, the first sensing pads 232a, the first connection portion 232b, and the second sensing pads 234a may also be formed as a single transparent conductive layer, while the second connection portion 234b may be formed as another conductive layer crossing the first connection portion 232b. Besides, a dielectric layer may be disposed between the second connection portion 234b and the first connection portion 232b to electrically insulate the second connection portion 234b and the first connection portion 232b from each other. However, the dispositions of the first sensing pads 232a, the first connection portion 232b, the second sensing pads 234a, and the second connection portion 234b may also be appropriately adjusted by those skilled in the art, and the dispositions, relative positions, and/or materials of the first sensing pads 232a, the first connection portion 232b, the second sensing pads 234a, and the second connection portion 234b are not limited in the invention.

Moreover, the touch panel 200 in the present embodiment further includes a plurality of signal lines 240 and a controller 250. The first sensing electrodes 232 and the second sensing electrodes 234 are respectively electrically connected to the controller 250 through different signal lines 240. It should be mentioned that only the relative electrical connections between each signal line 240 and the first sensing electrode 232 and the second sensing electrode 234 are illustrated in FIG. 2. In an actual application, the exact layout of the signal lines 240 may not be the same as that illustrated in FIG. 1 and can be hidden at other appropriate positions according to the actual requirement. Regarding the actual operation mechanism, when a user touches the sensing array 220 and a capacitance variation is produced at the touched position, the sensing array 220 outputs a capacitance variation signal to the controller 250 through the signal lines 240 so that the controller 250 can determine the position touched by the user.

In the present embodiment, the first sensing electrode 232 and the second sensing electrode 234 intersect each other. To be specific, the first connection portion 232b of the first sensing electrode 232 and the second connection portion 234b of the second sensing electrode 234 intersect each other. In the present embodiment, the second connection portion 234b and the first connection portion 232b may intersect each other perpendicularly and form an overlapping area A_{C} at the intersection. The shapes and sizes of the first sensing electrode 232 and the second sensing electrode 234 and the distance between the two may be determined according to the actual design requirement. For example, if the length L₂₃₂ₐ of the first sensing pads 232a is 3.7 mm, the width W₂₃₄ₐ of the second sensing pads 234a is 0.2 mm or 0.5 mm, and the width W_{234b} of the second connection portion 234b is 0.8 mm or 1 mm, the overlapping area A_{C}=1 mm * 1 mm=1 mm². The second connection portion 234b and the first connection portion 232b form a parallel-plate capacitor at the overlapping area A_{C}, and the parallel-plate capacitor has a second initial capacitance.

Below, the touch panel in FIG. 1 and the touch panel 200 in FIG. 2 will be compared, and the comparison result is shown in following table 1. According to the formula for parallel-plate capacitance (C=ε*A/d), a larger overlapping area results in a greater capacitance. Herein because the overlapping area A_{B} in FIG. 1 is greater than the overlapping area A_{C} in FIG. 2, it can be determined that the first initial capacitance of the touch panel in FIG. 1 is greater than the second initial capacitance of the touch panel in FIG. 2.

TABLE 1
Comparison between the touch panel in FIG. 1 and the
touch panel in FIG. 2

| | Initial | | | |
|---|---|---|---|---|
| | Capacitance | Detected | | Variation |
| | (pF) | Capacitance (pF) | Capacitance | Extent |
| | (not touched) | (touched) | Variation (pF) | (percentage) |
| FIG. 1 | 9.21 | 9.00 | 0.21 | −2.3% |
| FIG. 2 | 2.71 | 2.50 | 0.21 | −7.7% |

Referring to foregoing table 1, the initial capacitance is the capacitance produced by the first sensing electrode and the second sensing electrode before the touch panel is touched, and this capacitance is measured in units of pico farad (pF). The detected capacitance is the capacitance produced by the first sensing electrode and the second sensing electrode and detected by the controller after the touch panel is touched. The capacitance variation is the change of capacitance produced when the touch panel is touched. For example, the capacitance of a sensing unit 230 detected by the controller when the touch panel is not touched is 2.71 pF, and the capacitance of the sensing unit 230 detected when the touch panel is touched is 2.50 pF. Thus, the capacitance variation of the sensing unit 230 is 2.71 pF−2.50 pF=0.21 pF, and the variation extent of the sensing unit 230 is (−0.21/2.71)*100%=−7.7%.

As shown in table 1, the touch panel 200 in FIG. 2 offers a smaller initial capacitance compared to the bar type touch panel in FIG. 1, and this difference is mainly caused by the overlapping area between the first sensing electrode and the second sensing electrode. To be specific, the overlapping area A_{C} of the touch panel 200 in FIG. 2 is smaller than the overlapping area A_{B} of the touch panel in FIG. 1. Thus, based on the formula for parallel-plate capacitance, the initial capacitance in the present embodiment is smaller than that in the conventional technique. Accordingly, with the same capacitance variation, the touch panel 200 in FIG. 2 offers a greater variation extent. Namely, the touch panel 200 in FIG. 2 offers higher touch sensitivity.

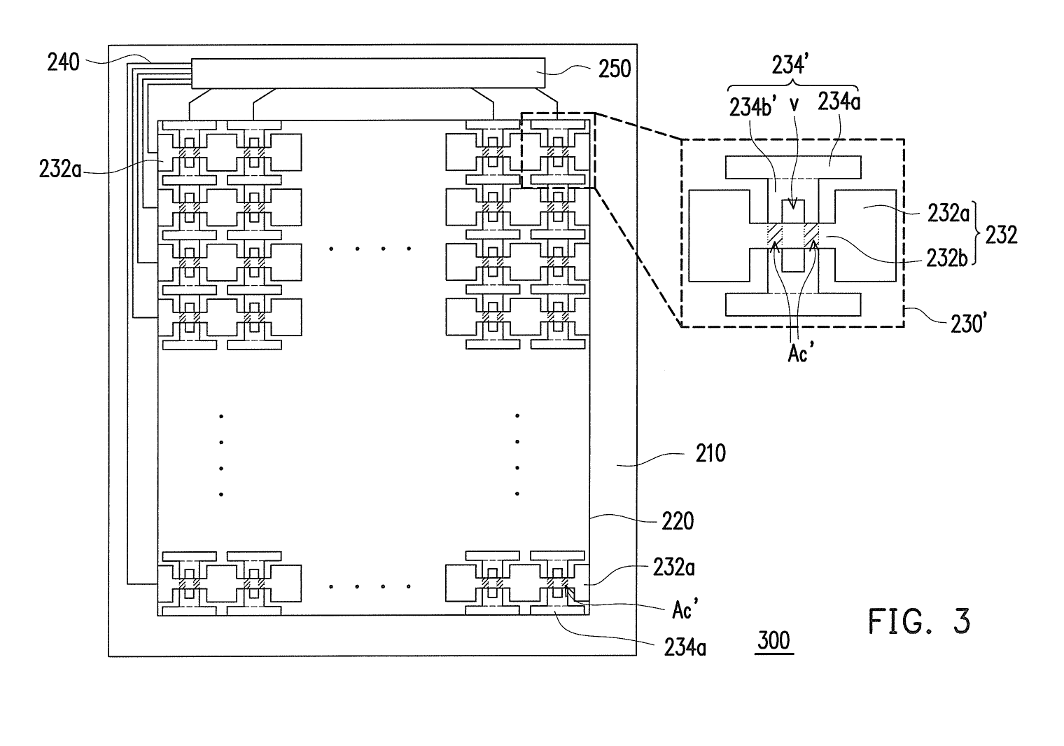

It should be noted that the technique of adjusting the overlapping area between the first sensing electrode and the second sensing electrode or the formation sequence of the first sensing electrode and the second sensing electrode is not limited in the invention. FIG. 3 is a top view of a touch panel according to another embodiment of the invention. The embodiment illustrated in FIG. 3 can be understood by referring to descriptions related to FIG. 2. The shape, size, and space of the sensing unit 230′ in FIG. 3 can be determined according to the actual design requirement. For example, the shape, size, and space of the sensing unit 230′ can be determined by referring to descriptions related to the sensing unit 230 in FIG. 2. For example, the width of the gap between the first sensing pad 232a and the second sensing pad 234a is 0.1 mm, the width of the second sensing pad 234a is 0.2 mm, the width of the second connection portion 234b′ is 0.8 mm, and the distance from the edge of the second sensing pad 234a to the edge of the sensing unit 230′ is 0.5-2 mm.

A difference between the embodiment illustrated in FIG. 2 and the embodiment illustrated in FIG. 3 is that in the touch panel 300 provided by the embodiment illustrated in FIG. 3, the second sensing electrode 234′ is formed before the first sensing electrode 232, and a hole V is formed at the intersection between the second connection portion 234b′ of the second sensing electrode 234′ and the first connection portion 232b. By appropriately adjusting the size of the hole V, the overlapping area A_{C}′ between the second connection portion 234b′ and the first connection portion 232b can be reduced, so that the coupling capacitance (i.e., mutual-capacitance) between the first sensing electrode 232 and the second sensing electrode 234′, and accordingly the initial capacitance of the sensing units 230′, can be effectively reduced.

Additionally, by appropriately adjusting the size of the hole V, the surface area of the second sensing electrode 234′ can be reduced. Namely, the self-capacitance of the second sensing electrode 234′ can be effectively reduced. With the decreases in the self-capacitance and mutual-capacitance of the second sensing electrode 234′, the resistance-capacitance (RC) load of the second sensing electrode 234′ is reduced. Thus, when the driving circuit of the touch panel 300 supplies a scan signal to the second sensing electrode 234′, the second sensing electrode 234′ with the reduced self-capacitance can reduce the loss of the scan signal. Accordingly, the touch sensitivity of the touch panel 300 is improved.

Moreover, even though the first sensing electrode 232 and the second sensing electrode 234′ are made of transparent materials, they still affect the transmittance of the touch panel 300. The transmittance of the touch panel 300 can be increased by appropriately increasing the size of the hole V. Accordingly, when the touch panel 300 is integrated and works with a display panel, the loss of backlight caused by the first sensing electrode 232 and the second sensing electrode 234′ can be reduced, the output luminance of the display panel can be increased, and an optimal touch sensitivity can be maintained. Even though the hole V is formed on the second connection portion 234b′ of the second sensing electrode 234′ in the present embodiment, the invention is not limited thereto. For example, in some embodiments, the hole V is formed in the second sensing pads 234a of the second sensing electrode 234′. Or, in some other embodiments, one or more holes V are respectively formed in second sensing pads 234a and the second connection portion 234b′ of the second sensing electrode 234′. In still some other embodiments, one or more holes V are formed on the first sensing electrode 232 by referring to related descriptions of the second sensing electrode 234′. Namely, one or more holes V are formed in the first sensing electrode 232 and/or the second sensing electrode 234′ according to the actual design requirement.

Below, the touch panel 300 in the FIG. 3 and the touch panel 200 in FIG. 2 are compared with each other, and the comparison result is listed in following table 2.

TABLE 2
Comparison between the touch panel in FIG. 2 and the
touch panel in FIG. 3

| | Initial | | | |
|---|---|---|---|---|
| | Capacitance | Detected | | Variation |
| | (pF) | Capacitance (pF) | Capacitance | Extent |
| | (not touched) | (touched) | Variation (pF) | (percentage) |
| FIG. 2 | 2.82 | 2.57 | 0.25 | −8.86% |
| FIG. 3 | 1.98 | 1.72 | 0.26 | −13.1% |

Referring to foregoing table 2, compared to the touch panel 200 in FIG. 2, the touch panel 300 in FIG. 3 offers a smaller initial capacitance and a smaller mutual-capacitance. This difference is caused by the size of the overlapping area between the first sensing electrode and the second sensing electrode. To be specific, because the overlapping area A_{C}′ of the touch panel 300 in FIG. 3 is smaller than that overlapping area A_{C} of the touch panel 200 in FIG. 2, based on the formula for parallel-plate capacitance, the initial capacitance in the present embodiment is smaller than that in the conventional technique. Thus, with the same capacitance variation, the touch panel 300 in FIG. 3 offers a greater variation extent. In other words, the touch sensitivity of the touch panel 300 is improved.

TABLE 3
Comparison between the touch panel in FIG. 2 and the
touch panel in FIG. 3

| | Self- | | | |
|---|---|---|---|---|
| | capacitance | | | |
| | of Scan | Self-capacitance of | Mutual- | |
| | Electrode | Read Electrode | capacitance | Variation |
| | (pF) | (pF) | (pF) | Extent (fF) |
| FIG. 2 | 33.45 | 53.79 | 2.82 | 249.7 |
| FIG. 3 | 24.35 | 37.67 | 1.98 | 262.2 |

Referring to FIG. 3, herein it is assumed that the first sensing electrode 232 in FIG. 3 is a scan electrode (or TX electrode) and the second sensing electrode 234′ in FIG. 3 is a read electrode (or RX electrode). Compared to the touch panel 200 in FIG. 2, in the touch panel 300 of FIG. 3, the mutual-capacitance between the scan electrode and the sensing electrode is reduced to 1.98 pF, the scan electrode self-capacitance of the touch panel 300 is reduced by 27%, and the sensing electrode self-capacitance of the touch panel 300 is reduced by 30%. Thereby, the touch sensitivity of each sensing unit 230′ of the touch panel 300 in FIG. 3 is improved.

As described above, in a touch panel provided by an embodiment of the invention, each of the first sensing electrodes and the second sensing electrode has an I-shaped structure composed of a plurality of rectangular sensing pads and a connection portion. By regulating the overlapping areas between the first sensing electrodes and the second sensing electrodes and/or the surface areas of the sensing electrodes, the initial capacitance of the touch panel is reduced and accordingly the touch sensitivity thereof is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel, comprising:
a substrate; and
a sensing array, disposed on the substrate, wherein the sensing array comprises a plurality of sensing units, and each of the sensing units comprises:
a first sensing electrode, comprising two first sensing pads disposed in parallel and a first connection portion, wherein the first sensing pads and the first connection portion are in rectangular shapes, and two short sides of the first connection portion are respectively electrically connected to middle portions of long sides of the first sensing pads; and
a second sensing electrode, wherein the second sensing electrode and the first sensing electrode are arranged in a staggered manner and are electrically insulated from each other, the second sensing electrode comprises two second sensing pads disposed in parallel and a second connection portion, the second sensing pads and the second connection portion are in rectangular shapes, two short sides of the second connection portion are respectively electrically connected to middle portions of long sides of the second sensing pads, and the second connection portion and the first connection portion intersect each other.

2. The touch panel according to claim 1, wherein the first sensing pads and the first connection portion of the sensing unit are disposed on a first plane, the second sensing pads and the second connection portion of the sensing unit are disposed on a second plane, and the first plane is different from the second plane.

3. The touch panel according to claim 1, wherein the first sensing pads and the first connection portion of the sensing unit are perpendicularly disposed, and the second sensing pads and the second connection portion of the sensing unit are perpendicularly disposed.

4. The touch panel according to claim 1, wherein the first connection portion and the second connection portion perpendicularly intersect each other, and each of the first sensing pads and each of the second sensing pads do not overlap each other.

5. The touch panel according to claim 1, wherein a plurality of first gaps exists between each of the first sensing pads and each of the second sensing pads, and a plurality of second gaps exists between each of the first sensing pads and the second connection portions.

6. The touch panel according to claim 5, wherein a width of each of the first gaps is 0.3 mm.

7. The touch panel according to claim 1, wherein a length of each of the first sensing pads is 3.7 mm.

8. The touch panel according to claim 1, wherein a width of each of the second sensing pads is 0.5 mm.

9. The touch panel according to claim 1, wherein a width of each of the second connection portions is 1 mm.

10. The touch panel according to claim 1, further comprising:
a plurality of signal lines; and
a controller, wherein each of the first sensing electrodes and each of the second sensing electrodes are respectively electrically connected to the controller through the signal lines.

11. The touch panel according to claim 1, wherein the second connection portion has a hole, and the second connection portion and the first connection portion intersect each other at the hole.
